(19) United States
(12) Patent Application Publication
(10) Pub. No.: US 2013/0201477 A1
(43) Pub. Date: Aug. 8, 2013

(54) ELEMENTARY ANALYSIS APPARATUS AND METHOD

(71) Applicants: Koji Kurita, Hitachinaka (JP); Toshihiro Shirasaki, Hitachinaka (JP); Hiroyuki Koshi, Hitachinaka (JP)

(72) Inventors: Koji Kurita, Hitachinaka (JP); Toshihiro Shirasaki, Hitachinaka (JP); Hiroyuki Koshi, Hitachinaka (JP)

(73) Assignee: HITACHI HIGH-TECHNOLOGIES CORPORATION, Tokyo (JP)

(21) Appl. No.: 13/638,186

(22) PCT Filed: Mar. 25, 2011
(86) PCT No.: PCT/JP2011/057319

§ 371 Date: Oct. 18, 2012

(30) Foreign Application Priority Data
Apr. 12, 2010 (JP) 2010-091371

(51) Int. Cl. G01N 21/31

(52) U.S. Cl. CPC G01N 21/3103
USPC 356/319; 356/437

(57) ABSTRACT

Provided herein is an elementary analysis apparatus allowing size and weight reduction and capable of performing atomic adsorption spectrometry by an electrothermal method and of forming plasma without using a gas. A sample is supplied from a liquid feed portion through a flow channel to an atomizing portion, and a voltage is applied between electrodes. When the voltage is applied to the electrodes, electric current and electric field are concentrated in the atomizing portion and bubbles are generated to cause a plasma in the bubbles, and element in the sample is atomized by the plasma. Light that irradiates the atomizing portion from a light source and is transmitted therethrough is received, for example, by an optical fiber or the like and split by a spectrophotometer. The amount of the split light is detected by a detector and analyzed by a computer.

### TECHNICAL FIELD

The present invention relates to an elementary analysis apparatus and a method for performing atomic absorption spectrometry.

### BACKGROUND ART

Inductively coupled plasma atomic emission analysis apparatus (ICP atomic emission analysis apparatus) and atomic absorption spectrophotometers have widely been used for elementary analysis.

The inductively coupled plasma atomic emission analysis apparatus can analyze multiple elements by measurement for once by selection of a spectrophotometer or selection of a detector.

In contrast, the atomic absorption spectrophotometer generally can measure a single element by measurement for once. For the atomic absorption spectrophotometer, a flame method and an electric heating furnace method are used. In the former, a sample is introduced into a flame and atomized therein. In the latter, a sample is dispensed into an electric heating furnace and heated and atomized by applying a voltage to the furnace. The elementary analysis method using the atomic absorption spectrophotometer is such that light is irradiated from a light source to the sample in an atomized state to measure absorbance.

As an example of the electrothermal method, a sample is heated by using high frequency induction heating described in a Patent Document 1 and atomized to generate plasma.

### PRIOR ART DOCUMENT

### Patent Document

Patent Document 1: JP-1-161651-A

### SUMMARY OF THE INVENTION

### Problem to be Solved by the Invention

However, in the technique described in the Patent Document 1, since the plasma is generated by using a high frequency power, a gas such as an argon gas is necessary for forming the plasma.

Accordingly, since the atomic absorption spectrophotometer using the electrothermal method in the prior art requires a gas supply means and a countermeasure for gas leakage in the gas supply means, it is increased in size and weight, and also inconvenient to handle with.

An object of the present invention is to provide an elementary analysis apparatus allowing size and weight reduction and an elementary analysis method, which is capable of performing atomic adsorption spectrometry by an electrothermal method and capable of forming plasma without using a gas.

### Means for Solving the Problem

To attain the object described above, the present invention has the following configuration.

A sample to be measured is located between two electrodes disposed in an atomizing portion, and a voltage is applied between the two electrodes. Bubbles are generated in the sample to be measured located between the two electrodes, plasma is generated in the bubbles, and light is transmitted through the generated plasma, whereby atomic absorption spectrometry is performed.

### Effect of the Invention

The present invention can provide an elementary analysis apparatus allowing size and weight reduction and an elementary analysis method, which is capable of performing atomic adsorption spectrometry by an electrothermal method and capable of forming plasma without using a gas.

### BRIEF DESCRIPTION OF THE DRAWINGS

FIG. 1 is an entire configurational view of an atomic absorption analysis apparatus using plasma for atomization as an embodiment of the present invention.

FIG. 2 is a configurational view showing an example of the periphery of an atomizing portion of the atomic absorption analysis apparatus shown in FIG. 1.

FIG. 3 is a graph for an example showing the result of measurement by atomic absorption spectrometry.

FIG. 4 is a flow chart showing the flow of an analyzing operation in the present invention.

### MODE FOR CARRYING OUT THE INVENTION

Embodiments of the present invention are to be described with reference to the accompanying drawings.

### Example

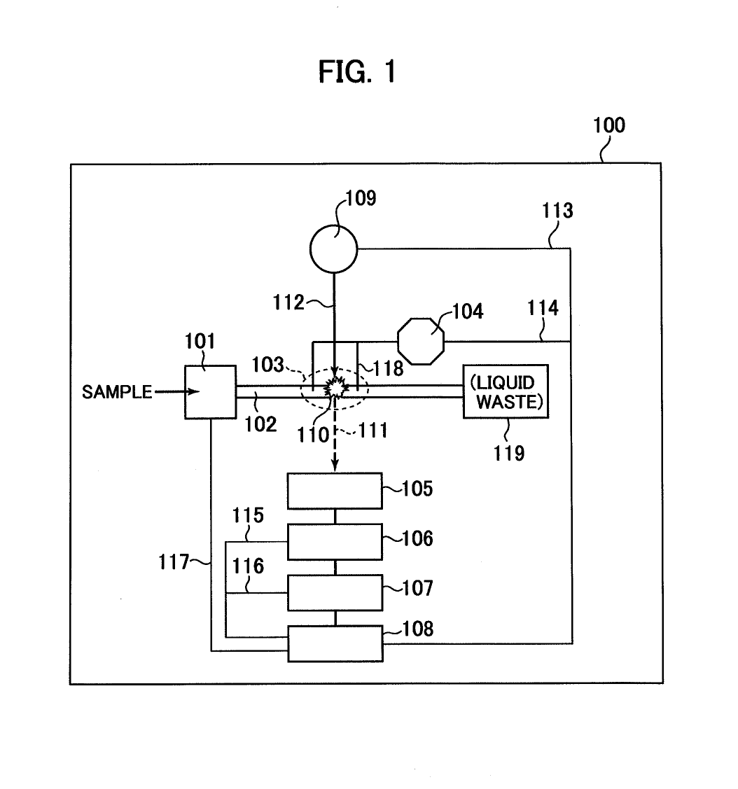

FIG. 1 is a schematic configurational view of an elementary analysis apparatus for performing atomic absorption spectrometry (plasma emission atomic absorption analysis apparatus) 100 performing atomic absorption spectrometry as an embodiment of the invention.

In FIG. 1, an elementary analysis apparatus includes a liquid feed portion 101, a flow channel 102, an atomizing portion 103, a power source device 104, an optical fiber 105, a spectrophotometer 106, a detector 107, a computer 108 and a light source 109. An atomic absorptiometric portion is formed of the optical fiber 105, the spectrophotometer 106, the detector 107 and the computer (operation control/analysis portion) 108.

Two electrodes 118 are disposed in the midway of the flow channel 102 and the atomizing portion 103 is located between the electrodes 118 to generate plasma 110. A liquid sample is supplied from the liquid feed portion 101 by way of the flow channel 102 to the atomizing portion 103, reaches from the atomizing portion 103 to a liquid waste portion 119 and is discharged as a liquid waste.

The flow channel 102 comprises quartz glass of 100 μm diameter for example.

Light 112 from the light source 109 transmits a sample located in the atomizing portion 103, a transmission light 111 is received by the optical fiber 105 and introduced into the spectrophotometer. Then, the light split by the spectrophotometer 106 is detected by the detector 107.

Further, for the light source 109, a hollow cathode lamp, a deuterium lamp, a tungsten iodide lamp, a xenon lamp, a light emitting diode, or the like can be used.

The computer 108 is connected to the liquid feed portion 101, the power source device 104, the spectrophotometer 106, and the detector 107, sends control signals 113, 114, 115, 116, and 117 to them respectively to control each of the devices. Further, the computer 108 analyzes a sample to be measured based on the light detected by the detector 107.

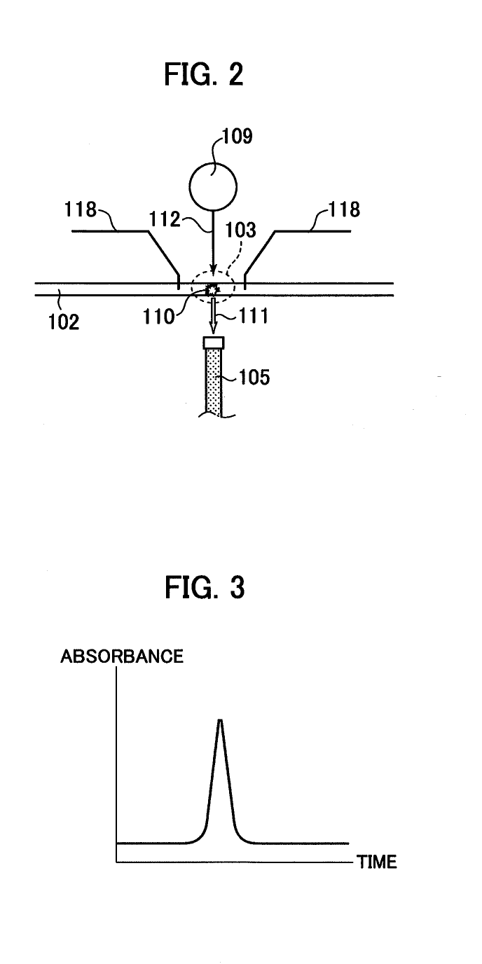

FIG. 2 is a graph showing details of the atomizing portion 103 shown in FIG. 1.

In FIG. 2, a sample supplied from the liquid feed portion 101 to the flow channel 102 fills the flow channel of the atomizing portion 103. Electrodes 118 comprising, for example, Pt and disposed in the flow channel 102 are connected to the power source device 104 and the computer 108 in FIG. 1.

The voltage applied from the power source device 104 to the electrodes 118 (for example, 2.5 kV), or a voltage application time, etc. are controlled by the control signals 114 from the computer 108.

When a voltage is applied in the flow channel 102 shown in FIG. 2 to a sample by using electrodes 118, electric current and electric field are concentrated in the atomizing portion 103 to generate bubbles, and plasma 110 is generated in the bubbles. The element contained in the sample is atomized by the plasma 110 to absorb the light 112 from the light source 109.

The light 111 passing through the plasma 110 is introduced by way of the optical fiber 105 to the spectrophotometer 106 and split. When the light is detected by the detector 107, an element in the sample solution can be analyzed. A condensing lens, etc. may also be used without using the optical fiber 105.

As described above, each of the devices is controlled by the computer 108 and also the conditions for the apparatus are input from an input portion (keyboard, etc.) and the result of analysis is indicated on a display portion of the computer 108. FIG. 3 shows an image of the analysis result, which is an example that can be displayed on the display portion of the computer 108. In FIG. 3, the ordinate represents absorbance (abs) and the abscissa represents the time (for example, on the unit of second).

Referring to the principle of the elementary analysis according to the invention, when plasma is generated between the electrodes 118, the element contained in the sample is excited and atomized by the plasma and, when the atomized element is irradiated with light, since the element causes resonance absorption of the light having a predetermined wavelength, the element in the sample is identified and determined by measuring the light.

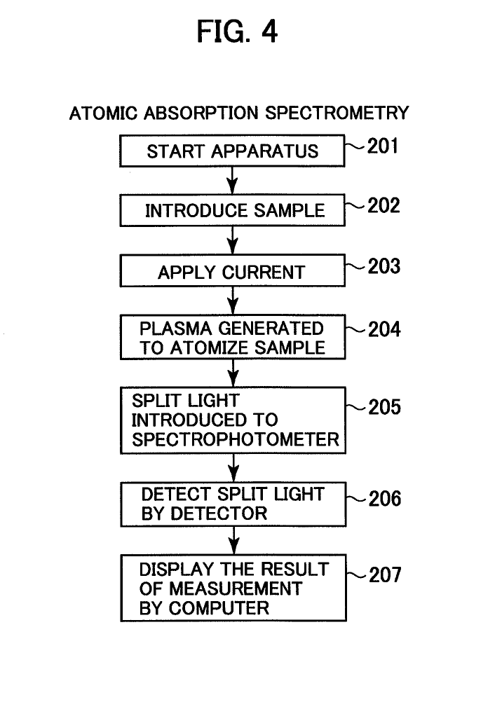

FIG. 4 is an operation flow chart in the measuring method according to the atomic absorptiometry in one embodiment.

In FIG. 4, an operator at first starts the analysis apparatus (step 201). Then, a sample is injected into a liquid feed portion 101 (for example, by syringe pump) and sent at a predetermined flow rate (for example, at 1 mL/min) to the flow channel 102 (step 202). After the flow channel 102 has been filled with the liquid sample, a control signal 114 is sent from the computer 108 to the power source device 104 so as to apply a voltage to the electrodes 118 (step 203).

When the voltage is applied to the electrodes 118, electric current and electric field are concentrated in the atomizing portion 103 of the flow channel 102, bubbles are generated, and a plasma 110 is generated in the bubbles. Then, the element in the sample is atomized by the plasma 110 (step 204).

Then, light 111 from the light source 109 (for example, hollow cathode lamp) which is irradiated from the light source 109 to the atomizing portion 103 and transmitted therethrough is received by the optical fiber 105 or the like and split by the spectrophotometer 106 (step 205). The amount of the split light is detected by the detector 107 (step 206).

Then, the absorbance is determined by the computer 108 based on the amount of the light detected by the detector 107 and displayed (step 207). By applying the voltage from the electrodes 118 plurality of times, the absorbance can be measured continuously.

Whether the sample is atomized or not in the atomizing portion 103 can be judged depending on whether the peak of the absorbance is detected or not as shown in FIG. 3. This is because the peak of the absorbance is not detected unless the sample is atomized.

Whether the bubbles are generated or not in the sample can be judged by monitoring the current between the electrodes 118. This is because the current between the electrodes decreases rapidly when the bubbles are generated.

Then, analysis procedures by atomic absorption spectrometry of Cd in a liquid sample such as river water according to an embodiment of the invention are shown below. For the river water used herein as the sample, a sample previously prepared to a 0.1 M nitric acid solution is used. The acid used for the analysis of the sample is not restricted to nitric acid or to the concentration of 0.1 M.

(1) A measurer inputs measuring conditions such as a voltage, a liquid feed rate, etc. to the computer 108. Measuring conditions are set on each of the portions of the analysis apparatus 100 by the control signals received from the computer 108. When the setting for the measurement conditions has been completed, indication therefor is displayed, for example, on a display portion of the computer 108. At the instance that setting for the measuring conditions has been completed, liquid supply, voltage application, and light from the light source are irradiated to the atomizing portion 103 located between the two electrodes 118.

(2) After completing the preparation of the liquid sample such as river water and setting of apparatus conditions, a liquid sample such as water river (after preparation) is injected and supplied to the liquid feed portion 101. The measurer starts liquid supply at a predetermined flow rate manually or by the control instruction of the computer 108.

(3) The liquid sample such as river water supplied at the predetermined flow rate passes through the flow channel 102 and fills the atomizing portion 103. Further supply of the liquid from the liquid feed portion 101 causes discharge of the liquid through the flow channel 102 from the liquid waste portion 119.

(4) When the atomizing portion 103 is filled with river water, a voltage is applied from the two electrodes 118 to the atomizing portion 103. The voltage application is controlled manually or by the computer 108. Items for the voltage application condition include a voltage value, an application time, an application interval (pulse voltage application interval), etc.

(5) When the voltage is applied, electric current and electric field are concentrated on the sample in the atomizing portion 103 by the two electrodes 118 to generate bubbles, and plasma is generated in the bubbles. In this case, Cd contained in the liquid sample such as river water is atomized and Cd absorbs light having a predetermined wavelength of light irradiated from the light source 109.

(6) The light 111 transmitting through the flow channel 102 and the sample is received by the optical fiber 105, introduced to the spectrophotometer 106, split therein, and then detected by the detector 107. The element can be analyzed by monitoring light having a predetermined wavelength in the detector 107.

(7) Calibration curves are prepared based on the absorbances obtained by measuring a sample not containing Cd and a sample containing a known amount of Cd by the methods (1) to (6) described above, and comparison between the absorbances obtained by analysis on river water is made, thereby attaining quantitative analysis of Cd.

As described above, according to the embodiment of the invention, since the plasma can be formed without using a gas, gas supply means and a countermeasure for gas leakage from the gas supply means are not necessary and it is possible to provide an elementary analysis apparatus reducible in size and weight and method, which is capable of performing atomic absorption spectrometry by the electrothermal method.

As a modified example of the embodiment described above, it is also possible to provide the light source 109 with plural kinds of lamps such as a hollow cathode lamp, and a deuterium lamp, a tungsten iodide lamp, a xenon lamp, and a light emitting diode, and drive one of the plural kinds of lamps by the computer 108 in accordance with the sample to be measured. Thus, plural kinds of elements can be measured by one analysis apparatus.

In the example described above, the liquid sample is discarded at the liquid waste portion 119 but it is also possible to provide a flow channel for returning the sample from the liquid waste portion 119 to the liquid feed portion 101, perform atomization, analyze the sample again, and then discard the liquid waste.

Further, for the flow channel 102, materials other than quartz glass are also applicable so long as the materials are transparent and acid resistant and cause no metal contamination to the sample. For example, a silicon tube may also be used as the flow channel 102.

### DESCRIPTION OF REFERENCE NUMERALS

100 Plasma emission spectroscopic atomic absorption analysis apparatus
101 Liquid supply portion
102 Flow channel
103 Atomizing portion
104 Power source device
105 Optical fiber
106 Spectrophotometer
107 Detector
108 Computer
109 Light source
110 Plasma
111 Light after transmitting sample
112 Light from light source
113, 114, 115, 116, 117 Control signal
118 Electrode
119 Liquid waste portion

1. An atomic absorption elementary analysis apparatus, comprising:
an atomizing portion for atomizing a sample to be measured,
two electrodes disposed for the atomizing portion,
a power source portion for applying a voltage to the two electrodes to generate a plasma in the sample to be measured located in the atomizing portion,
a light source for irradiation of the atomizing portion light, and
an atomic absorptiometric portion for detecting light that has been from the light source and has passed through a plasma generated in the sample to be measured located in the atomizing the atomic absorptiometric portion further analyzing the atomic absorption of the sample to be measured.

2. The atomic absorption elementary analysis apparatus according to claim 1,
wherein the atomic absorptiometric portion includes a spectrophotometer for splitting light that has been from the light source and has passed through the plasma generated in the sample to be measured, and a detector for detecting light split by the spectrophotometer.

3. The atomic absorption elementary analysis apparatus according to claim 2,
wherein the apparatus further includes a flow channel connected to the atomizing portion, and a liquid feed portion for supplying the sample to be measured by way of the flow channel to the atomizing portion.

4. The atomic absorption elementary analysis apparatus according to claim 3,
wherein the atomic absorptiometric portion has an operation control/analysis portion for controlling operations of the power source portion, the light source, and the liquid feed portion.

5. The atomic absorption elementary analysis apparatus according to claim 4,
wherein the light source has plural kinds of light source lamps, and one of the plural kinds of light source lamps is selected by the operation control-analysis portion to generate light.

6. The atomic absorption elementary analysis apparatus according to claim 5,
wherein the plural kinds of light source lamps include a hollow cathode lamp, a deuterium lamp, a tungsten iodide lamp, a xenon lamp, and a light emitting diode.

7. An atomic absorption elementary analysis method which includes:
situating a sample to be measured between two electrodes, and applying a voltage to the two electrodes to generate a plasma in the sample to be measured,
irradiating the generated plasma with light from the light source, and
detecting light that has been from the light source and has passed through the plasma generated in the sample to be measured and analyzing atomic absorption of the sample to be measured.

8. The atomic absorption elementary analysis method according to claim 7,
wherein the light that has been from the light source and has passed through the plasma generated in the sample to be measured is split, the split light is detected and the atomic absorption of the sample to be measured is analyzed.

9. An atomic absorption elementary analysis method according to claim 8,
wherein the light source has plural kinds of light source lamps, and one of the plural kinds of light source lamps is selected to generate light.

10. An atomic absorption elementary analysis method according to claim 9,
wherein the plural kinds of light source lamps include a hollow cathode lamp, a deuterium lamp, a tungsten iodide lamp, a xenon lamp, and a light emitting diode.
